(19) United States
(12) Patent Application Publication
(10) Pub. No.: US 2020/0143983 A1
(43) Pub. Date: May 7, 2020

(54) Wireless Powering Device And Electrical Apparatus

(71) Applicant: Tyco Electronics (Shanghai) Co. Ltd., Shanghai (CN)

(72) Inventors: Chenxi Wang, Shanghai (CN); Shaoyong Wang, Shanghai (CN); Feng Dai, Shanghai (CN); Yuming Song, Shanghai (CN)

(73) Assignee: Tyco Electronics (Shanghai) Co. Ltd., Shanghai (CN)

(21) Appl. No.: 16/733,692

(22) Filed: Jan. 3, 2020

Related U.S. Application Data
(63) Continuation of application No. PCT/EP2018/068096, filed on Jul. 4, 2018.

(30) Foreign Application Priority Data
Jul. 5, 2017 (CN) 201710541610.6

(51) Int. Cl. H01F 38/14; H01F 27/28; H02J 50/10; H02J 7/00

(52) U.S. Cl. CPC H01F 38/14; H02J 7/0042; H02J 50/10; H01F 27/2804

(57) ABSTRACT

A wireless powering device includes a plurality of transmitting coils and a single transmitting circuit board to which the transmitting coils are electrically connected in series.

### CROSS-REFERENCE TO RELATED APPLICATIONS

This application is a continuation of PCT International Application No. PCT/EP2018/068096, filed on Jul. 4, 2018, which claims priority under 35 U.S.C. § 119 to Chinese Patent Application No. 201710541610.6, filed on Jul. 5, 2017.

### FIELD OF THE INVENTION

The present invention relates to a powering device and, more particularly, to a wireless powering device.

### BACKGROUND

The emergence of wireless power supply technology has brought great convenience to the power supply of moving parts in electrical apparatuses. The wireless power supply technology may completely avoid many problems caused by physical wear, for example, along with problems related to safety, service life, and maintenance of the electrical apparatus. Moreover, the wireless power supply technology may greatly enhance the degree of freedom in the structural design of the electrical apparatus, and increase the aesthetic and functional features of the electrical apparatus, especially consumer electrical equipment, such as household appliances.

A wireless power supply device comprises a transmitting module and a receiving module, and the transmitting module must correspond to the receiving module one to one. At present, the most common wireless power supply technology is based on electromagnetic coupling. Generally, the wireless power supply device based on the electromagnetic coupling comprises a transmitting coil and a receiving coil. The transmitting coil must correspond to the receiving coil one to one. When the transmitting coil and the receiving coil are moved to close to each other, they are electromagnetically coupled to each other.

However, in practical applications, there is often a situation in which a load may be placed at any one of a plurality of different locations of the electrical apparatus. For example, in a refrigerator, a carrier may be placed at any suitable location of the plurality of different locations according to a height of an object to be loaded on the carrier. In order to supply power to a load (for example, a lamp, or a fan) mounted on the carrier, a transmitting module must be provided at each of the plurality of different locations. In this way, all transmitting modules may work at any time, leading to energy waste.

### SUMMARY

A wireless powering device includes a plurality of transmitting coils and a single transmitting circuit board to which the transmitting coils are electrically connected in series.

### BRIEF DESCRIPTION OF THE DRAWINGS

The invention will now be described by way of example with reference to the accompanying Figures, of which:

FIG. 1 is a perspective view of an electrical apparatus according to an embodiment;

FIG. 2 is a perspective view of a wireless powering device according to an embodiment;

FIG. 3 is a perspective view of a wireless powering device according to another embodiment; and

FIG. 4 is a perspective view of a wireless powering device according to another embodiment.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

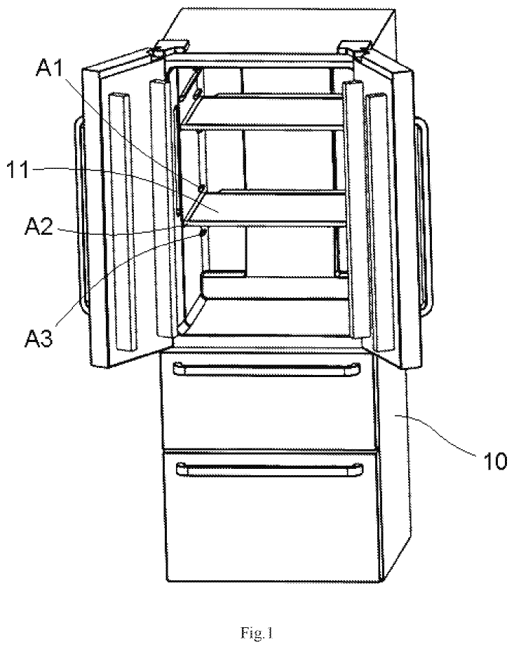

An electrical apparatus according to an embodiment is shown in FIG. 1. The electrical apparatus in the embodiment of FIG. 1 is a refrigerator. In other embodiments, the electrical apparatus may be any other electrical apparatus, such as a washing machine, an air conditioner, etc.

As shown in FIG. 1, in an embodiment, a carrier (also referred to as a tray) 11 is provided in the refrigerator. The carrier 11 may be placed at any one of a plurality of different locations A1, A2, A3 of the refrigerator according to a height of an object to be loaded on the carrier 11. A load (not shown) is mounted on the carrier 11, and the load may comprise a lamp, a display, a fan, etc. When the carrier 11 is placed at one location of the plurality of different locations A1, A2, A3, the wireless powering device will power the load mounted on the carrier 11.

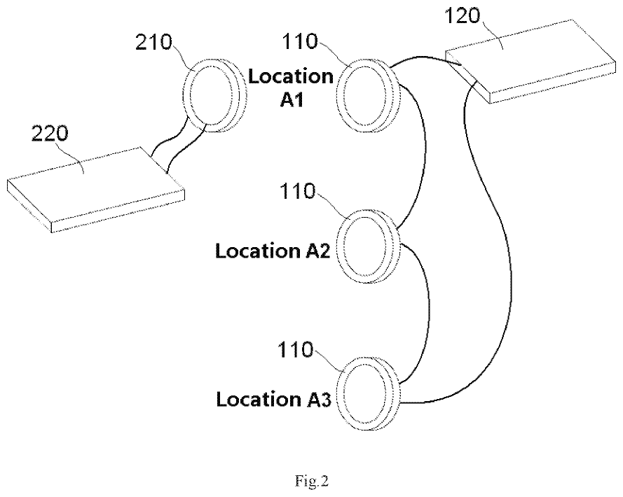

A wireless powering device according to an embodiment, as shown in FIG. 2, comprises a plurality of transmitting coils 110, a single transmitting circuit board 120, a single receiving coil 210, and a single receiving circuit board 220. The plurality of transmitting coils 110 are located at a plurality of different locations A1, A2, A3 of the electrical apparatus, respectively. The plurality of transmitting coils 110 are electrically connected in series to the single transmitting circuit board 120. The single receiving coil 210 is mounted on the carrier 11 of the electrical apparatus. The receiving coil 210 is electrically connected to the receiving circuit board 220.

After the carrier 11 loaded with the receiving coil 210 is mounted at one location of the plurality of different locations A1, A2, A3 of the electrical apparatus, the receiving coil 210 mounted on the carrier 11 is electromagnetically coupled with the transmitting coil 110 mounted at the one location to supply power for the load mounted on the carrier 11.

In the embodiment shown in FIG. 2, the transmitting coil 110 is formed by winding a wire, and the transmitting coil 110 is a component separate from the transmitting circuit board 120. The plurality of transmitting coils 110 are connected in series with each other by welding or pressing. In other embodiments, the plurality of transmitting coils 110 may be connected in series with each other by wires or electrical connectors. In the embodiment shown in FIG. 2, the receiving coil 210 is formed by winding a wire, and the receiving coil 210 is a component separate from the receiving circuit board 220.

The plurality of transmitting coils 110, as shown in FIG. 2, are arranged in a common vertical plane. In other embodiments, the plurality of transmitting coils 110 may be arranged in different planes. Adjacent transmitting coils 110 of the plurality of transmitting coils 110 have a same current direction in the shown embodiment. In other embodiments, adjacent transmitting coils 110 of the plurality of transmitting coils 110 may have opposite current directions.

In an embodiment, the receiving coil 210 is movably mounted on the electrical apparatus, so that the receiving coil 210 is movable within a coverage of an electromagnetic field of the plurality of transmitting coils 110.

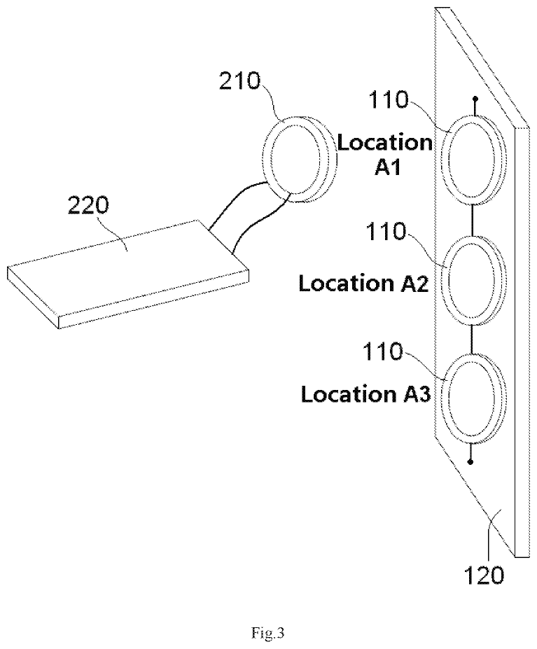

A wireless powering device according to another embodiment, as shown in FIG. 3, comprises a plurality of transmitting coils 110, a single transmitting circuit board 120, a single receiving coil 210, and a single receiving circuit board 220. The plurality of transmitting coils 110 are located at a plurality of different locations A1, A2, A3 of the electrical apparatus, respectively. The plurality of transmitting coils 110 are electrically connected in series to the single transmitting circuit board 120. The single receiving coil 210 is mounted on the carrier 11 of the electrical apparatus and electrically connected to the receiving circuit board 220.

After the carrier 11 loaded with the receiving coil 210 is mounted at one location of the plurality of different locations A1, A2, A3 of the electrical apparatus, the receiving coil 210 mounted on the carrier 11 is electromagnetically coupled with the transmitting coil 110 mounted at the one location to supply power for the load mounted on the carrier 11.

In the embodiment shown in FIG. 3, the transmitting coil 110 is formed by winding a wire, and the transmitting coil 110 is a component fixed and integrated on the transmitting circuit board 120. The plurality of transmitting coils 110 are connected in series with each other by conductive traces printed on the transmitting circuit board 120. In the embodiment shown in FIG. 3, the receiving coil 210 is formed by winding a wire, and the receiving coil 210 is a component separate from the receiving circuit board 220.

As shown in FIG. 3, in an embodiment, the plurality of transmitting coils 110 are arranged in a row in a vertical direction on a surface of the transmitting circuit board 120. In other embodiments, the plurality of transmitting coils 110 may be irregularly arranged on the surface of the transmitting circuit board 120. Adjacent transmitting coils 110 of the plurality of transmitting coils 110 have a same current direction. In other embodiments, adjacent transmitting coils 110 of the plurality of transmitting coils 110 may have opposite current directions.

The receiving coil 210 is movably mounted on the electrical apparatus, so that the receiving coil 210 is movable within a coverage of an electromagnetic field of the plurality of transmitting coils 110.

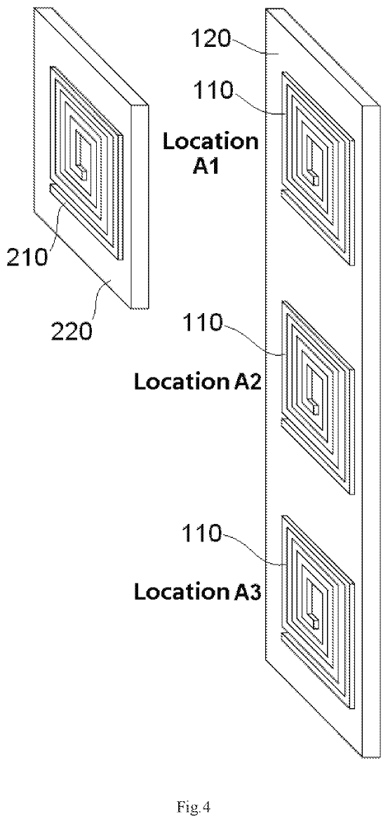

A wireless powering device according to another embodiment, as shown in FIG. 4, comprises a plurality of transmitting coils 110, a single transmitting circuit board 120, a single receiving coil 210, and a single receiving circuit board 220. The plurality of transmitting coils 110 are located at a plurality of different locations A1, A2, A3 of the electrical apparatus, respectively. The plurality of transmitting coils 110 are electrically connected in series to the single transmitting circuit board 120. The single receiving coil 210 is mounted on the carrier 11 of the electrical apparatus and electrically connected to the receiving circuit board 220.

After the carrier 11 loaded with the receiving coil 210 is mounted at one location of the plurality of different locations A1, A2, A3 of the electrical apparatus, the receiving coil 210 mounted on the carrier 11 is electromagnetically coupled with the transmitting coil 110 mounted at the one location to supply power for the load mounted on the carrier 11.

In the embodiment shown in FIG. 4, the transmitting coil 110 is a coil printed on the transmitting circuit board 120. The plurality of transmitting coils 110 are connected in series with each other by conductive traces printed on the transmitting circuit board 120. In the embodiment shown in FIG. 4, the receiving coil 210 is a coil printed on the receiving circuit board 220.

As shown in FIG. 4, in an embodiment, the plurality of transmitting coils 110 are arranged in a row in a vertical direction on a surface of the transmitting circuit board 120. In other embodiments, the plurality of transmitting coils 110 may be irregularly arranged on the surface of the transmitting circuit board 120. In an exemplary embodiment, adjacent transmitting coils 110 of the plurality of transmitting coils 110 have a same current direction. In other embodiments, adjacent transmitting coils 110 of the plurality of transmitting coils 110 may have opposite current directions.

The receiving coil 210 is movably mounted on the electrical apparatus, so that the receiving coil 210 is movable within a coverage of an electromagnetic field of the plurality of transmitting coils 110.

The electrical apparatus shown in FIG. 1 comprises the carrier 11, a load, and the wireless powering device described in any one of the above embodiments. As shown in FIGS. 1-4, after the carrier 11 loaded with the receiving coil 210 is mounted at one location of the plurality of different locations A1, A2, A3 of the electrical apparatus, the receiving coil 210 is electromagnetically coupled with the transmitting coil 110 mounted at the one location to supply power for the load mounted on the carrier 11.

In the above exemplary embodiments, the transmitting coil 110 may be mounted at each of the plurality of different locations A1, A2, A3 of the electrical apparatus. Therefore, when the carrier 11 loaded with the receiving coil 210 and the load is placed at one location of the plurality of different locations A1, A2, A3, the receiving coil 210 and the transmitting coil 110 at the one location will be electromagnetically coupled with each other. Therefore, in the present disclosure, it is unnecessary to check the location of the receiving coil 210 and the load. In addition, it is unnecessary to provide a plurality of independent circuit boards for the plurality of transmitting coils 110, which greatly improves the hardware utilization, simplifies the complexity of the wireless powering device, and reduces the cost.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A wireless powering device, comprising:
a plurality of transmitting coils; and
a single transmitting circuit board to which the transmitting coils are electrically connected in series.

2. The wireless powering device of claim 1, wherein the transmitting coils are mounted at a plurality of different locations of an electrical apparatus.

3. The wireless powering device of claim 2, further comprising a receiving coil mounted at one location of the plurality of different locations of the electrical apparatus and electromagnetically coupled with one of the transmitting coils.

4. The wireless powering device of claim 3, further comprising a single receiving circuit board to which the receiving coil is electrically connected.

5. The wireless powering device of claim 4, wherein the receiving coil is mounted on a carrier of the electrical apparatus, the carrier is mounted at the one location of the plurality of different locations to electromagnetically couple the receiving coil with the one of the transmitting coils.

6. The wireless powering device of claim 4, wherein the receiving coil is movably mounted on the electrical apparatus and is movable within a coverage of an electromagnetic field of the transmitting coils.

7. The wireless powering device of claim 4, wherein each of the transmitting coils is formed by winding a wire, and the transmitting coils are each a component separate from the transmitting circuit board.

8. The wireless powering device of claim 7, wherein the transmitting coils are connected in series with each other by welding or pressing.

9. The wireless powering device of claim 7, wherein the transmitting coils are connected in series with each other by wires or electrical connectors.

10. The wireless powering device of claim 4, wherein each of the transmitting coils is formed by winding a wire, and the transmitting coils are each a component fixed and integrated on the transmitting circuit board.

11. The wireless powering device of claim 4, wherein the transmitting coils are connected in series with each other by a plurality of conductive traces printed on the transmitting circuit board.

12. The wireless powering device of claim 4, wherein each of the transmitting coils is a coil printed on the transmitting circuit board.

13. The wireless powering device of claim 4, wherein the receiving coil is formed by winding a wire, and the receiving coil is a component separate from the receiving circuit board.

14. The wireless powering device of claim 4, wherein the receiving coil is formed by winding a wire, and the receiving coil is a component fixed and integrated on the receiving circuit board.

15. The wireless powering device of claim 4, wherein the receiving coil is a coil printed on the receiving circuit board.

16. The wireless powering device of claim 1, wherein the transmitting coils are arranged in a common plane.

17. The wireless powering device of claim 1, wherein the transmitting coils are arranged in different planes.

18. The wireless powering device of claim 1, wherein adjacent transmitting coils of the transmitting coils have a same current direction.

19. The wireless powering device of claim 1, wherein adjacent transmitting coils of the transmitting coils have opposite current directions.

20. An electrical apparatus, comprising:
a carrier mounted at one of a plurality of different locations;
a load mounted on the carrier; and
a wireless powering device supplying power to the load, the wireless powering device including a plurality of transmitting coils and a single transmitting circuit board to which the transmitting coils are electrically connected in series.
